(19) United States
(12) Patent Application Publication
(10) Pub. No.: US 2004/0261040 A1
(43) Pub. Date: Dec. 23, 2004

(54) Method and apparatus for media access control

(75) Inventors: Mark J. Radcliffe, Seattle, WA (US); Kathleen E. Demaree, Snohomish, WA (US); Nadja Vol-Ochs Wilson, Duvall, WA (US)

Correspondence Address: LEE & HAYES PLLC, 421 W RIVERSIDE AVENUE SUITE 500, SPOKANE, WA, 99201

(73) Assignee: MICROSOFT CORPORATION, REDMON, WA (US)

(21) Appl. No.: 10/601,785

(22) Filed: Jun. 23, 2003

(51) Int. Cl. G09G 5/00; H04N 5/445

(52) U.S. Cl. 715/840; 715/843; 715/810; 725/39

(57) ABSTRACT

A graphical user interface for a media player includes a button associated with accessing media stored on a computing system. An actuation mechanism enables a user to select the button. Selection of the button causes the media player to obtain information regarding media available to the user and to display the information regarding media available to the user in a hierarchical manner.

### TECHNICAL FIELD

The systems and methods described herein relate to accessing media data from one or more sources.

### BACKGROUND

As hard drive storage space on computer systems increases, users are storing more media items on their computer systems. These media items include music files, video files, and streaming media links (e.g., Internet radio stations). When a user wants to play a particular media item, the user wants to quickly and easily select the desired media item from hundreds or thousands of different media items. An unstructured listing of media items would frustrate the user having to sort through a large number of media items individually.

The media items stored on a particular computer system may be accessed by different application programs. If each application program uses a different media selection mechanism, it may be tedious for the user to learn several different media selection mechanisms. Using different media selection mechanisms to access the same media data is inefficient from a computing standpoint.

Accordingly, it is desirable to provide a media selection mechanism that is efficient to implement and is consistent across different application programs.

### SUMMARY

The systems and methods described herein provide an efficient media selection mechanism that uses a consistent user experience across multiple applications or components. A common media access server identifies and stores various media data. A media access client accesses media data from the media access server. The media access clients aggregate and categorize the media data received from the media access server. Media access clients also display the media data to a user in a consistent manner using a common user interface.

In a particular embodiment, a graphical user interface for a media player includes a button associated with accessing media stored on a computing system. An actuation mechanism enables a user to select the button, which causes the media player to obtain information regarding media available to the user and to display the information regarding media available to the user in a hierarchical manner.

In another embodiment, a request for media data is received from a media access client. In response to the request, one or more stored media items and one or more stored media lists are identified. Information regarding the one or more stored media items and the one or more stored media lists are provided to the media access client.

### BRIEF DESCRIPTION OF THE DRAWINGS

Similar reference numbers are used throughout the figures to reference like components and/or features.

FIG. 1 is a block diagram of an example computing environment.

FIG. 2 is a flow diagram illustrating an embodiment of a procedure for aggregating media data and allowing clients to access the aggregated media data.

FIG. 3 is a flow diagram illustrating an embodiment of a procedure for identifying various media information.

FIG. 4 illustrates an example of a user interface generated by a media player application.

FIG. 5 illustrates an example of a user interface generated by a secondary media player application.

FIG. 6 illustrates an example of a user interface generated by an online services application.

FIG. 7 illustrates a general computer environment, which can be used to implement the techniques described herein.

### DETAILED DESCRIPTION

The methods and systems discussed herein provide a scalable component that aggregates and categorizes media data, such as audio files, video files, playlists, and media devices. The methods and systems organize the media information and respond to user interaction to provide a quick media selection mechanism for choosing media from potentially thousands of media items and other media data stored in a computer system. The user interface control can be implemented in a variety of different components within multiple application environments to provide a consistent user interface across a user's computer system.

As used herein, an “audio file” is any file containing any audio data and a “video file” is a file containing any video data. A “media list” is a list of audio files, video files or other information related to, for example, a particular artist, a particular album, or a particular genre. Another type of media list is a “playlist”. A “playlist” is any listing of audio files, video files, or other data files that may not have any particular relationship to one another. Particular examples of playlists are discussed below. A “media device” is any device capable of generating, recording and/or communicating media data. Example media devices include CD Drives, DVD Drives, portable audio players, televisions, and radio broadcasts. As used herein, a “media item” is any audio data, video data, streaming media link, or other data that represents or identifies a media source.

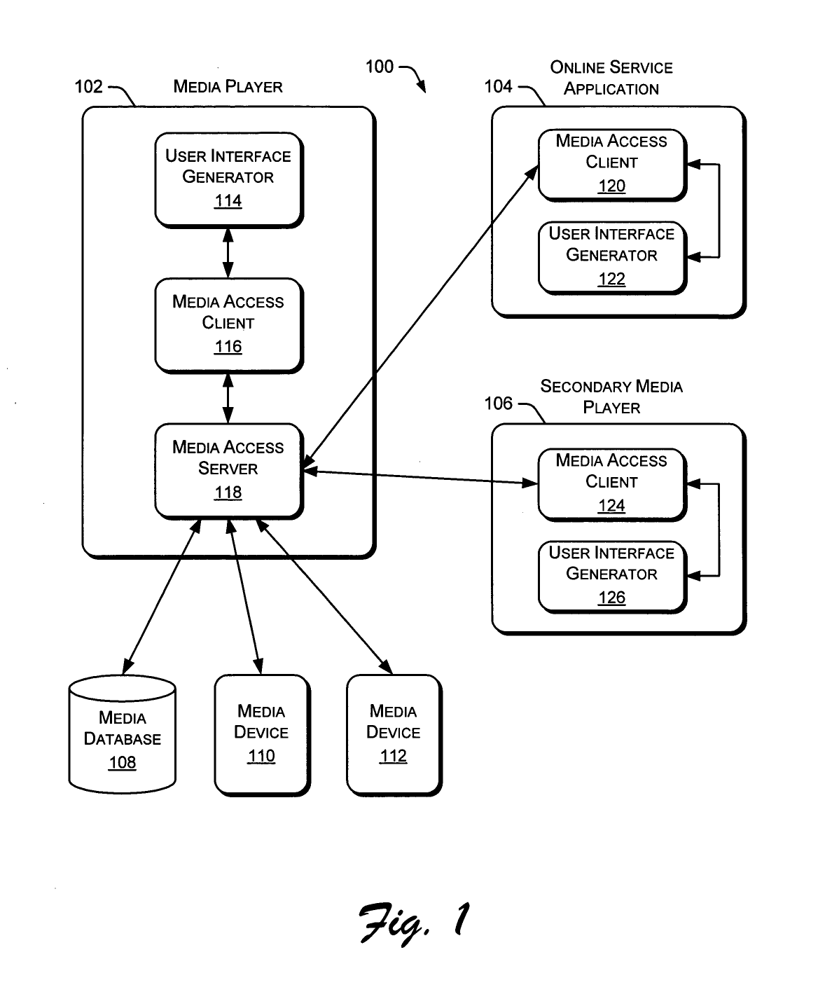

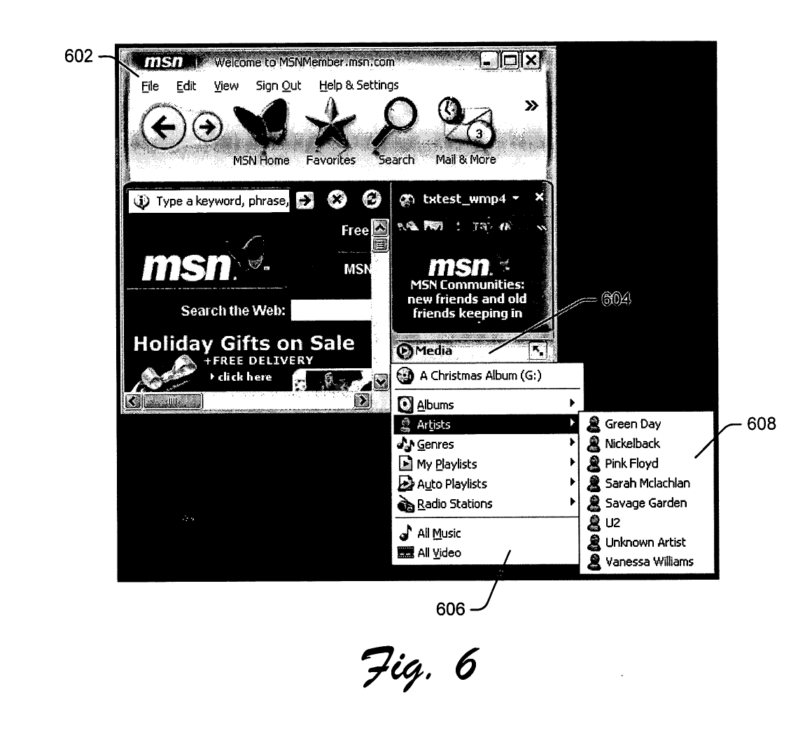

FIG. 1 is a block diagram of an example computing environment 100. A media player 102 is coupled to an online service application 104 and a secondary media player 106. Media player 102 is also coupled to a media database 108 and two media devices 110 and 112. Media player 102 can be any type of media recording and/or playback application, such as the Windows Media® Player available from Microsoft Corporation of Redmond, Wash. Online service application 104 provides access to various online services. In one embodiment, online service application 104 is the MSN® network of Internet services supported by Microsoft Corporation. Secondary media player 106 may be associated with media player 102. For example, secondary media player 106 may generate an icon/interface, which is positioned in a task bar when media player 102 is minimized. An example secondary media player icon/interface is shown in FIG. 5.

Media player 102 is capable of receiving, storing and playing various media items, such as audio files and video files. Media player 102 includes a user interface generator 114 coupled to a media access client 116, which is coupled to a media access server 118. Media access server 118 receives media data from a variety of sources, such as media devices 110 and 112. Media devices 110 and 112 may be CD players (or CD drives), DVD players (or DVD drives), or other devices capable of providing media data to media access server 118. Media devices 110 and 112 may be permanently installed in the computing system (e.g., a CD drive or a DVD drive) or may be temporarily coupled to the computing system (e.g., a portable music player coupled to the computing system via a universal serial bus (USB) connection). Media access server 118 stores media data to media database 108 and retrieves stored media data from media database 108. Media database 108 can also store other information, such as configuration information, used by media access server 118 and media player 102.

Media access client 116 receives information from media access server 118. The received information is aggregated and categorized for use by user interface generator 114. User interface generator 114 generates a user interface for display on a display device, such as a computer monitor. The user interface allows a computer user to select a particular media item by, for example, navigating through a hierarchy of media items.

Online service application 104 includes a media access client 120 coupled to a user interface generator 122. Media access client 120 receives information from media access server 118. The received information is aggregated and categorized for use by user interface generator 122. User interface generator 122 generates a user interface for display on a display device, such as a computer monitor. Similar to user interface generator 114, user interface generator 122 generates a user interface that allows a computer user to select a particular media item by, for example, navigating through a hierarchy of media items.

Secondary media player 106 includes a media access client 124 coupled to a user interface generator 126. Media access client 124 receives information from media access server 118. The received information is aggregated and categorized for use by user interface generator 126. User interface generator 126 generates a user interface for display on a display device, such as a computer monitor. Similar to user interface generator 114, user interface generator 126 generates a user interface that allows a computer user to select a particular media item by, for example, navigating through a hierarchy of media items.

As shown in FIG. 1, multiple media access clients 116, 120 and 124 access a common media access server 118. Thus, rather than providing a separate media access server for each application or component in a computing system that handles media items, a single media access server provides the necessary server functions for any number of media access clients.

In a particular embodiment, a computer system includes one implementation of media access client 116 (shown in media player 102). This media access client is used by other applications, such as online service application 104 and secondary media player 106. In this embodiment, media access client 120 and media access client 124 are instantiations of media access client 116.

Similarly, a computer system may include one implementation of user interface generator 114 (shown in media player 102). The user interface generator is used by other applications. In this embodiment, user interface generator 122 and user interface generator 126 are instantiations of user interface generator 114.

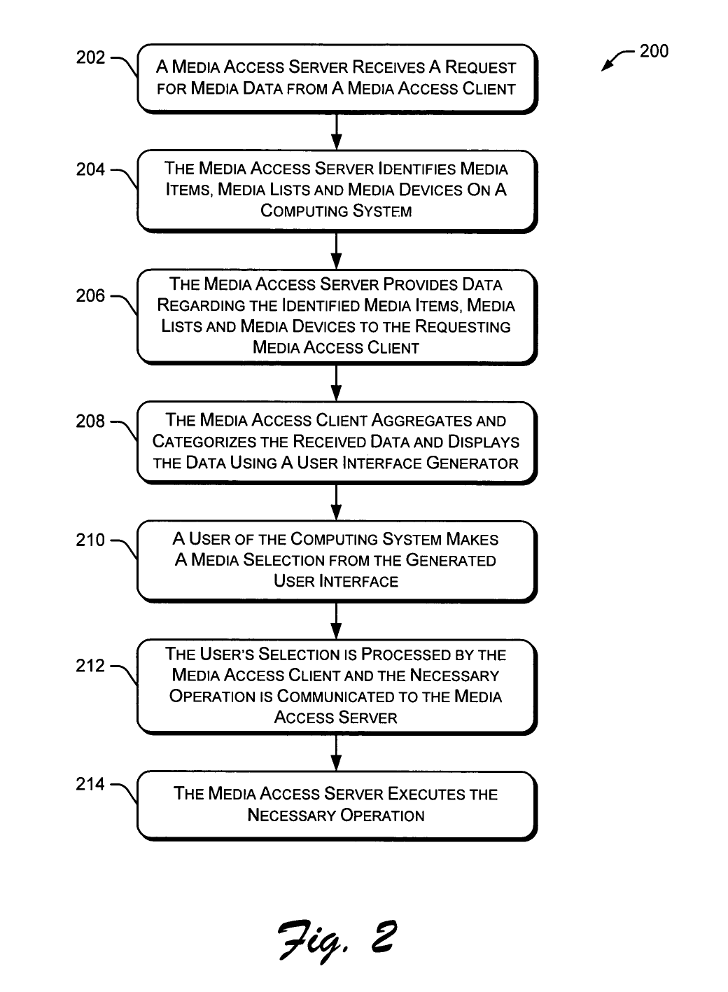

FIG. 2 is a flow diagram illustrating an embodiment of a procedure 200 for aggregating media data and allowing clients to access the aggregated media data. Initially, a media access server receives a request for media data from a media access client (block 202). The request for media data may be generated, for example, by a user request to play a media item or access a media device. The media access server identifies media items, media lists and media devices stored on or coupled to a computing system (block 204). The media access server then provides data regarding the identified media items, media lists and media devices to the requesting media access client (block 206). The media access server does not necessarily retrieve the actual media data. Instead, information regarding the media data is identified and provided to the media access client. For example, instead of providing a music file to the media access client, the media access server provides information regarding the music file, such as title, author, etc.

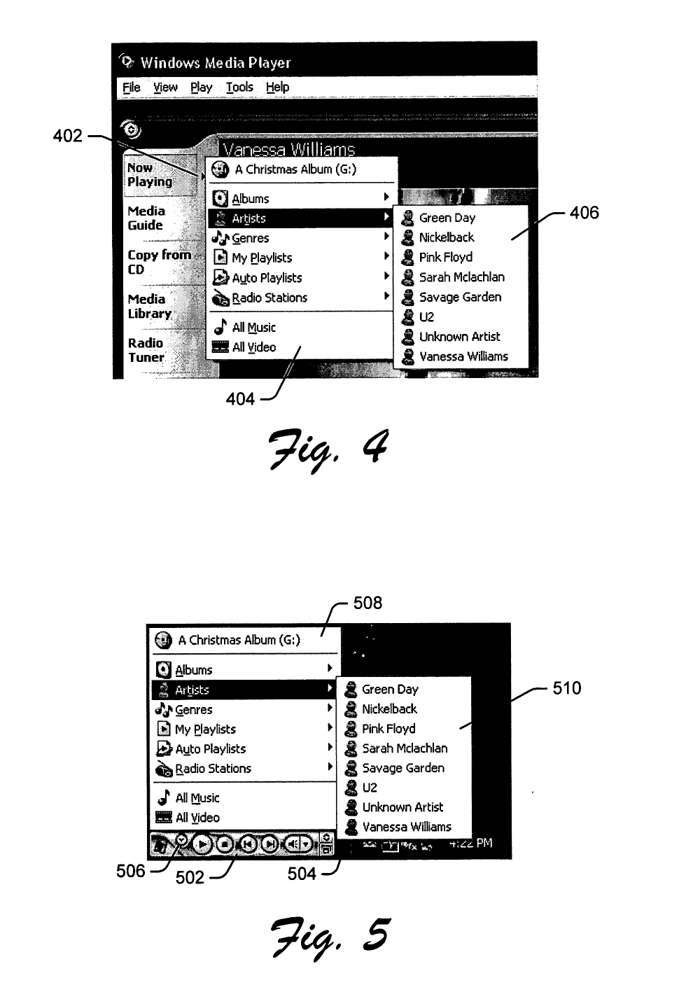

The requesting media access client receives the data from the media access server. The requesting media access client then aggregates and categorizes the received data and displays the data using the user interface generator (block 208). This aggregation and categorization of media data eliminates the need for a user to have prior knowledge of the physical location of media items, media playlists and/or media devices by aggregating the media data into a single user interface. Categorizing the aggregated data aids the user in selecting one or more desired media items, playlists, or devices. For example, media data can be categorized by artist name, album name, genre, and the like. Example user interfaces are discussed below with respect to FIGS. 4-6.

A user of the computing system makes a media selection using the user interface generated by the user interface generator (block 210). The user's selection is processed by the media access client and the necessary operation is communicated to the media access server (block 212). The media access server then executes the necessary operation (block 214), such as playing a selected media item or activating a media device.

In an example implementation of the procedure described above, a user of online service application 104 (FIG. 1) activates (e.g., launches) media access client 120. Media access client 120 sends a request for media data to media access server 118. Media access client 120 receives media data regarding various media items, media lists and media devices accessible through media access server 118. Media access client generates a user interface using user interface generator 122. The user of online service application 104 selects a media item, media list or media device via the user interface. The user's selection is then processed and the appropriate operation is performed. For example, if the user selected a particular song to play, that song is played for the user. Alternatively, if the user selected a particular media device, the audio or video data contained in that media device is played for the user.

In the embodiment discussed above, the media access client aggregates and categorizes media data received from the media access server. In an alternate embodiment, the media access server aggregates and categorizes the media data prior to providing the media data to the media access client. In this embodiment, the aggregation and categorization tasks are shifted to the media access server, thereby simplifying the tasks to be performed by the media access clients.

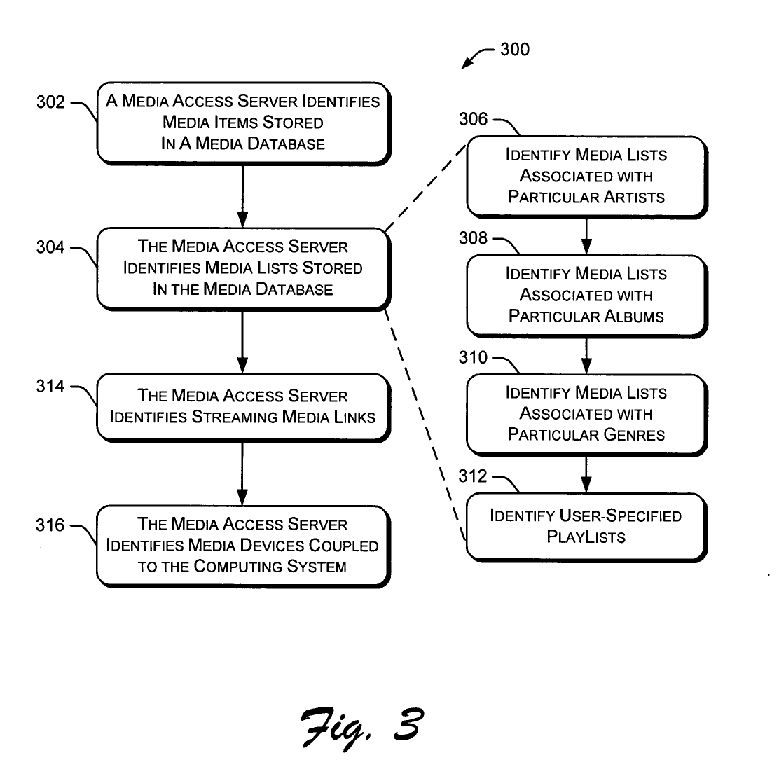

FIG. 3 is a flow diagram illustrating an embodiment of a procedure 300 for identifying various media information. In the example of FIG. 3, procedure 300 is performed by a media access server. In alternate embodiments, one or more other devices may perform procedure 300. Initially, a media access server identifies media items, such as audio files and video files, stored in a media database (block 302). These media items may include an associated title, artist, genre, duration and other information that may be of interest to a user selecting a media item or a system that is categorizing multiple media items.

The media access server also identifies media lists stored in the media database (block 304). The process of identifying media lists may include several separate operations, as shown in FIG. 3. The media access server identifies media lists associated with particular artists (block 306) and identifies media lists associated with particular albums (block 308). Media lists associated with particular artists may be collections of audio files or video files associated with particular artists, such as Green Day, Nickelback, Pink Floyd, U2, etc. Media lists associated with particular albums typically include collections of audio files or video files originally copied or “sourced” from the same CD, DVD, or other source. An example media list associated with a particular album includes Our Garden, Greatest Hits, The Train Wreck, New Town Dog, Moonlight Haze, etc.

The media access server also identifies media lists associated with particular genres (block 310), such as music genres, and identifies user-specified playlists (block 312). Media lists associated with particular genres may include audio files related to a similar genre of music, such as Classical, Country, Jazz, Rock or Soundtracks. Media lists associated with user-specified playlists include, for example, collections of audio or video files created by the user. Example playlists include favorite rock songs, movie songs, high energy music and favorite movie clips.

Another type of playlist that can be accessed by the media access server is an automatically generated playlist. An automatically generated playlist is created based on a user's viewing and/or listening habits or other factors. Examples include a playlist of songs typically listened to in the evening, a playlist of fresh (e.g., recently copied to the computer) music tracks, unrated music tracks, and unrated video clips.

Referring again to FIG. 3, the procedure continues at block 314 where the media access server identifies streaming media links. These streaming media links may include network-based radio station presets (e.g., Internet radio stations). These streaming media links can be assigned by a user of the computer, installed automatically based on user preferences or listening habits, or installed as default presets. Example streaming media links include Online Jazz, MSNBC, Oldies Radio, 80s Radio, 90s Radio, etc.

Finally, the media access server identifies media devices coupled to the computing system (block 316). Media devices include, for example, CD Drives, DVD Drives, portable audio players, portable video players, and the like. Information regarding the identified media items, media lists, streaming media links and media devices can be stored in the media database 108 (FIG. 1) for future access by the media access server.

Particular embodiments discussed herein identify media items, media lists, streaming media links and media devices in response to a request for such data from a media access client. This identification of media information may be performed in response to each request from a media access client. In an alternate embodiment, the media information may be identified periodically and stored (e.g., cached) for use in response to requests from media access clients.

FIG. 4 illustrates an example of a user interface generated by a media player application. In the example of FIG. 4, the media player application is the Windows Media® Player available from Microsoft Corporation. The user interface displayed by the media player application includes a triangular button 402 to the right of the “Now Playing” button. When a user moves a cursor (such as a mouse cursor) over triangular button 402, the appearance of the triangular button changes (e.g., the button is highlighted) to indicate that the user can interact with the button by clicking on the button. The appearance of triangular button 402 changes back to its original appearance when the cursor moves away from the triangular button.

If a user activates triangular button 402 (e.g., by clicking a mouse button while the mouse cursor is positioned over triangular button 402), a window 404 opens. The information contained in window 404 allows a user to access any media item, playlist, or media device stored on or coupled to the computer system. The top of window 404 illustrates media drives available on the computer system and the media content currently in the drive (e.g., A Christmas Album (G:)). Window 404 also displays a listing of media items by Album, Artist and Genre, User Playlists, Auto Playlists, Radio Stations (e.g., streaming media sources), and complete listings of all music and all video on the computer system. If the user selects a media drive (e.g., G:), the media player application begins playing the media currently in the media drive. If the user selects “Albums”, a listing of albums stored on the computer system (e.g., in a media database) is displayed for the user. Selecting a particular album from the list causes the media player application to begin playing songs or video content associated with the selected album. If the user selects “Artists”, a listing of artists stored on the computer system is displayed. In the example of FIG. 4, another window 406 is opened to display the list of artists available to the media player application. Selecting a particular artist in window 406 causes the media player application to begin playing songs or video content associated with that artist.

If the user selects “Genres”, a listing of various genres of music stored on the computer system is displayed. Selecting a particular genre from the list causes the media player application to begin playing songs associated with the selected genre. If the user selects “My Playlists”, a listing of user playlists stored on the computer system is displayed. Selecting a particular playlist causes the media player application to begin playing songs from the selected playlist. If the user selects “Auto Playlists”, a listing of automatically generated playlists stored on the computer system is displayed. Selecting a particular auto playlist causes the media player application to begin playing songs from the auto playlist.

If the user selects “Radio Stations”, a listing of various network-based radio stations (such as Internet radio stations) is displayed. Selecting a particular network-based radio station from the list causes the media player application to access the streaming media link associated with the network-based radio station. If the user selects “All Music”, a listing of all audio files stored on the computer system is displayed. Selecting a particular audio file from the list causes the media player application to begin playing the selected audio file. If the user selects “All Video”, a listing of all video files stored on the computer system is displayed. Selecting a particular video file from the list causes the media player application to begin playing the selected video file.

The user interface shown in FIG. 4 allows a user to quickly access any type of media content stored on the computer system. In one embodiment, the user interface shown in FIG. 4 is provided in addition to other interface features commonly available through a media player application. In this embodiment, one or more of the features of the user interface shown in FIG. 4 may be redundant with interface features offered by the media player application.

The hierarchy shown in FIG. 4 allows a user to easily navigate through a large number of audio and/or video files stored on the computer system. Although the user has access to all media items, playlists and media devices associated with the computer system, the user can quickly select a particular file or group of files (e.g., playlist, all files on an album or all files associated with a particular artist) for playback.

FIG. 5 illustrates an example of a user interface generated by a secondary media player application. As mentioned above, the secondary media player may be associated with another media player application. In one embodiment, the secondary media player is a task bar media player which is represented as an icon/interface in a task bar when the primary media player application (e.g., media player 102) is minimized. The icon/interface is represented by reference number 502 in FIG. 5, which shows the icon/interface in a task bar 504 of a Windows® screen. When a button 506 is activated in icon/interface 502, a window 508 opens. Window 508 contains content similar to the information displayed in window 404 (FIG. 4). The content in window 508 is similar to the content in window 404 because the media data used to generate the windows is obtained from the same media access server. This similarity in windows 508 and 404 enhances the user's experience with the computer system because the user need not learn a different user interface for different media players. When different instances of the same application are identical, the user is presented with the same user interface. Thus, the user can perform identical actions to operate the user interface. When a user selects one of the items listed in window 508, an action is taken as discussed above with respect to FIG. 4. For example, if the user selects “Artists” in window 508, another window 510 opens that contains a listing of artists stored on the computer system is displayed to the user of the computer system.

FIG. 6 illustrates an example of a user interface generated by an online services application. In one embodiment, the online services application is the MSN® network of Internet services supported by Microsoft Corporation. FIG. 6 illustrates a logon (or home) screen 602 displayed to users of the online services application. When a media button 604 is activated by a user, a window 606 is displayed. Window 606 contains content similar to (or identical to) the information displayed in window 404 (FIG. 4) and window 508 (FIG. 5). The content in window 606 is similar to the content in windows 404 and 508 because the media data used to generate the windows is obtained from the same media access server. This similarity in windows 606, 508 and 404 enhances the user's experience with the computer system because the user need not learn a different user interface for different media-related applications. When a user selects one of the items listed in window 606, an action is taken as discussed above with respect to FIG. 4. For example, if the user selects “Artists” in window 606, another window 608 opens that contains a listing of artists stored on the computer system is displayed to the user of the computer system.

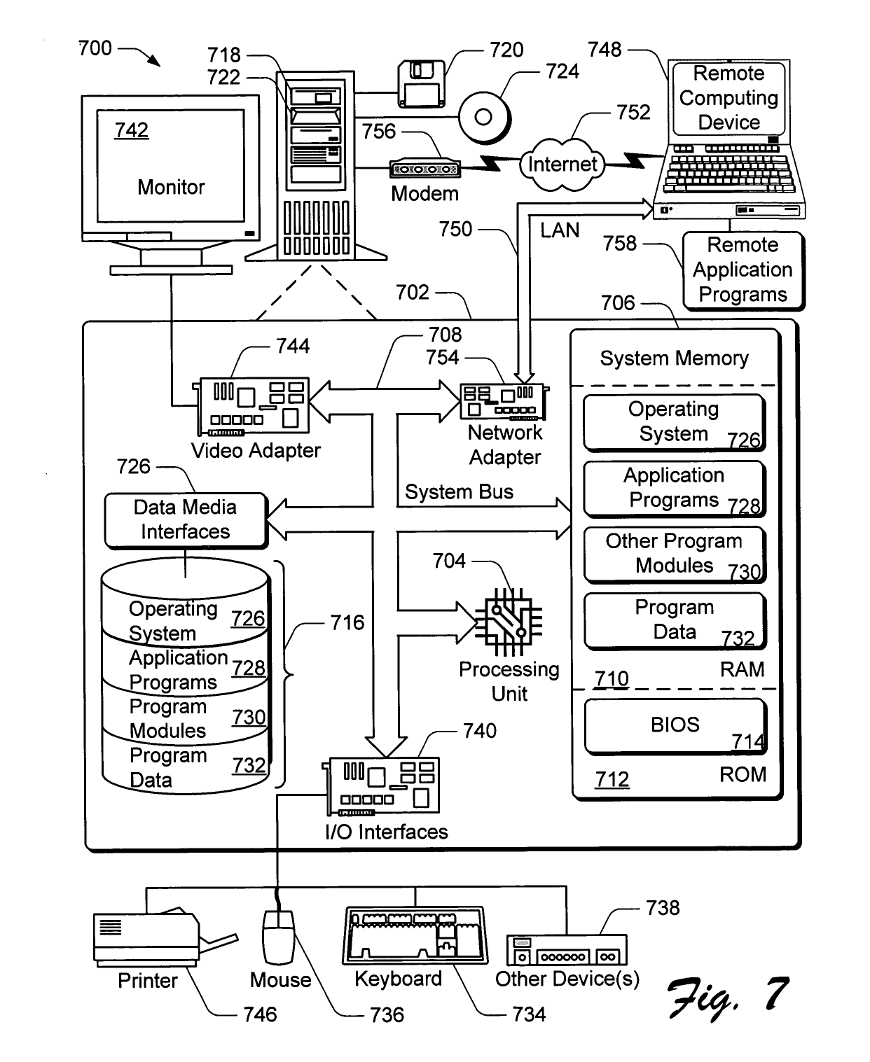

FIG. 7 illustrates a general computer environment 700, which can be used to implement the techniques described herein. The computer environment 700 is only one example of a computing environment and is not intended to suggest any limitation as to the scope of use or functionality of the computer and network architectures. Neither should the computer environment 700 be interpreted as having any dependency or requirement relating to any one or combination of components illustrated in the example computer environment 700.

Computer environment 700 includes a general-purpose computing device in the form of a computer 702. The components of computer 702 can include, but are not limited to, one or more processors or processing units 704 (optionally including a cryptographic processor or co-processor), a system memory 706, and a system bus 708 that couples various system components including the processor 704 to the system memory 706.

The system bus 708 represents one or more of any of several types of bus structures, including a memory bus or memory controller, a peripheral bus, an accelerated graphics port, and a processor or local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

Computer 702 typically includes a variety of computer readable media. Such media can be any available media that is accessible by computer 702 and includes both volatile and non-volatile media, removable and non-removable media.

The system memory 706 includes computer readable media in the form of volatile memory, such as random access memory (RAM) 710, and/or non-volatile memory, such as read only memory (ROM) 712. A basic input/output system (BIOS) 714, containing the basic routines that help to transfer information between elements within computer 702, such as during start-up, is stored in ROM 712. RAM 710 typically contains data and/or program modules that are immediately accessible to and/or presently operated on by the processing unit 704.

Computer 702 may also include other removable/non-removable, volatile/non-volatile computer storage media. By way of example, FIG. 7 illustrates a hard disk drive 716 for reading from and writing to a non-removable, non-volatile magnetic media (not shown), a magnetic disk drive 718 for reading from and writing to a removable, non-volatile magnetic disk 720 (e.g., a “floppy disk”), and an optical disk drive 722 for reading from and/or writing to a removable, non-volatile optical disk 724 such as a CD-ROM, DVD-ROM, or other optical media. The hard disk drive 716, magnetic disk drive 718, and optical disk drive 722 are each connected to the system bus 708 by one or more data media interfaces 726. Alternatively, the hard disk drive 716, magnetic disk drive 718, and optical disk drive 722 can be connected to the system bus 708 by one or more interfaces (not shown).

The disk drives and their associated computer-readable media provide non-volatile storage of computer readable instructions, data structures, program modules, and other data for computer 702. Although the example illustrates a hard disk 716, a removable magnetic disk 720, and a removable optical disk 724, it is to be appreciated that other types of computer readable media which can store data that is accessible by a computer, such as magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like, can also be utilized to implement the example computing system and environment.

Any number of program modules can be stored on the hard disk 716, magnetic disk 720, optical disk 724, ROM 712, and/or RAM 710, including by way of example, an operating system 726, one or more application programs 728, other program modules 730, and program data 732. Each of such operating system 726, one or more application programs 728, other program modules 730, and program data 732 (or some combination thereof) may implement all or part of the resident components that support the distributed file system.

A user can enter commands and information into computer 702 via input devices such as a keyboard 734 and a pointing device 736 (e.g., a “mouse”). Other input devices 738 (not shown specifically) may include a microphone, joystick, game pad, satellite dish, serial port, scanner, and/or the like. These and other input devices are connected to the processing unit 704 via input/output interfaces 740 that are coupled to the system bus 708, but may be connected by other interface and bus structures, such as a parallel port, game port, or a universal serial bus (USB).

A monitor 742 or other type of display device can also be connected to the system bus 708 via an interface, such as a video adapter 744. In addition to the monitor 742, other output peripheral devices can include components such as speakers (not shown) and a printer 746 which can be connected to computer 702 via the input/output interfaces 740.

Computer 702 can operate in a networked environment using logical connections to one or more remote computers, such as a remote computing device 748. By way of example, the remote computing device 748 can be a personal computer, portable computer, a server, a router, a network computer, a peer device or other common network node, game console, and the like. The remote computing device 748 is illustrated as a portable computer that can include many or all of the elements and features described herein relative to computer 702.

Logical connections between computer 702 and the remote computer 748 are depicted as a local area network (LAN) 750 and a general wide area network (WAN) 752. Such networking environments are commonplace in offices, enterprise-wide computer networks, intranets, and the Internet.

When implemented in a LAN networking environment, the computer 702 is connected to a local network 750 via a network interface or adapter 754. When implemented in a WAN networking environment, the computer 702 typically includes a modem 756 or other means for establishing communications over the wide network 752. The modem 756, which can be internal or external to computer 702, can be connected to the system bus 708 via the input/output interfaces 740 or other appropriate mechanisms. It is to be appreciated that the illustrated network connections are exemplary and that other means of establishing communication link(s) between the computers 702 and 748 can be employed.

In a networked environment, such as that illustrated with computing environment 700, program modules depicted relative to the computer 702, or portions thereof, may be stored in a remote memory storage device. By way of example, remote application programs 758 reside on a memory device of remote computer 748. For purposes of illustration, application programs and other executable program components such as the operating system are illustrated herein as discrete blocks, although it is recognized that such programs and components reside at various times in different storage components of the computing device 702, and are executed by the data processor(s) of the computer.

Various modules and techniques may be described herein in the general context of computer-executable instructions, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

An implementation of these modules and techniques may be stored on or transmitted across some form of computer readable media. Computer readable media can be any available media that can be accessed by a computer. By way of example, and not limitation, computer readable media may comprise “computer storage media” and “communications media.”

“Computer storage media” includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

Although the description above uses language that is specific to structural features and/or methodological acts, it is to be understood that the invention defined in the appended claims is not limited to the specific features or acts described. Rather, the specific features and acts are disclosed as exemplary forms of implementing the invention.

1. A graphical user interface for a media player, the graphical user interface comprising:
a button associated with accessing media stored on a computing system; and
an actuation mechanism to enable a user to select the button, whereupon selection of the button causes the media player to obtain information regarding media available to the user and to display the information regarding media available to the user in a hierarchical manner.

2. A graphical user interface as recited in claim 1 wherein the display of information regarding media available to the user includes a listing of audio files arranged by artist.

3. A graphical user interface as recited in claim 1 wherein the display of information regarding media available to the user includes a listing of audio files arranged by album.

4. A graphical user interface as recited in claim 1 wherein the display of information regarding media available to the user includes a list of audio files arranged by genre.

5. A graphical user interface as recited in claim 1 wherein the display of information regarding media available to the user includes at least one media device.

6. A graphical user interface as recited in claim 1 wherein the display of information regarding media available to the user includes a plurality of playlists.

7. A graphical user interface for a media player, the graphical user interface comprising:
a media access button associated with accessing media stored on a computing system; and
a hierarchical menu associated with the media access button, the hierarchical menu listing media available to the user of the computing system, whereupon selection of an entry in the hierarchical menu causes the media player to play a media item associated with the selection.

8. A graphical user interface as recited in claim 7 wherein the entry in the hierarchical menu is a listing of media items arranged by artist.

9. A graphical user interface as recited in claim 7 wherein the entry in the hierarchical menu is a listing of media items arranged by album.

10. A graphical user interface as recited in claim 7 wherein the entry in the hierarchical menu is a listing of media items arranged by genre.

11. A graphical user interface as recited in claim 7 wherein the entry in the hierarchical menu is a listing of available media drives.

12. A graphical user interface as recited in claim 7 wherein the entry in the hierarchical menu is a playlist of media items.

13. A graphical user interface as recited in claim 7 wherein the entry in the hierarchical menu is a listing of streaming media links.

14. A method comprising:
receiving a request for media data from a media access client;
identifying one or more stored media items;
identifying one or more stored media lists; and
providing information regarding the one or more stored media items and the one or more stored media lists to the media access client.

15. A method as recited in claim 14 further comprising categorizing the information regarding the one or more stored media items and the one or more stored media lists.

16. A method as recited in claim 14 wherein the one or more stored media items include audio files.

17. A method as recited in claim 14 wherein the one or more stored media items include video files.

18. A method as recited in claim 14 wherein the one or more stored media items include streaming media links.

19. A method as recited in claim 14 wherein the one or more stored media lists include lists of audio files arranged by audio file artist.

20. A method as recited in claim 14 wherein the one or more stored media lists include lists of audio files arranged by an album associated with the each audio file.

21. A method as recited in claim 14 wherein the one or more stored media lists include lists of audio files arranged by a genre associated with the each audio file.

22. A method as recited in claim 14 further comprising:
identifying one or more stored playlists; and
providing information regarding the one or more stored playlists to the media access client.

23. A method as recited in claim 22 wherein the one or more stored playlists are user-specified playlists.

24. A method as recited in claim 14 further comprising:
identifying one or more media devices; and
providing information regarding the one or more media devices to the media access client.

25. A method as recited in claim 24 wherein the one or more media devices are CD players.

26. A method as recited in claim 24 wherein the one or more media devices are DVD players.

27. One or more computer-readable memories containing a computer program that is executable by a processor to perform the method recited in claim 14.

28. A method comprising:
generating a request for media data;
receiving information regarding one or more media items;
receiving information regarding one or more media devices;
categorizing the information regarding the one or more media items and the one or more media devices; and
generating a user interface containing the categorized information.

29. A method as recited in claim 28 further comprising:
receiving information regarding one or more media lists; and
categorizing the information regarding the one or more media lists.

30. A method as recited in claim 28 further comprising:
receiving information regarding one or more playlists; and
categorizing the information regarding the one or more playlists.

31. A method as recited in claim 28 further comprising:
receiving a user selection entered through the user interface, wherein the 11 user selection has an associated operation; and
communicating the associated operation to a media access server.

32. A method as recited in claim 31 wherein the media access server performs the associated operation.

33. A method as recited in claim 31 wherein the associated operation is playing a media item.

34. A method as recited in claim 28 wherein the one or more media items include audio files.

35. A method as recited in claim 28 wherein the one or more media items include video files.

36. A method as recited in claim 28 wherein the one or more media items include streaming media links.

37. One or more computer-readable memories containing a computer program that is executable by a processor to perform the method recited in claim 28.

38. A method comprising:
receiving a request for media data from a media access client;
identifying one or more media items stored in a media database;
identifying one or more media lists stored in a media database;
identifying one or more media devices; and
providing information regarding the one or more media items, the one or more media lists, and the one or more stored media devices to the media access client.

39. A method as recited in claim 38 further comprising:
receiving a request to perform an operation from the media access client; and
performing the requested operation.

40. A method as recited in claim 39 wherein performing the requested operation includes playing a media item.

41. One or more computer-readable memories containing a computer program that is executable by a processor to perform the method recited in claim 38.

42. An apparatus comprising:
a media access server;
a media database coupled to the media access server;
a first media device coupled to the media access server;
a first media access client coupled to the media access server; and
a second media access client coupled to the media access server, wherein the media access server identifies media items stored in the media database and provides information regarding the identified media items and the first media device to the first media access client and the second media access client.

43. An apparatus as recited in claim 42 further comprising a user interface generator coupled to the first media access client, wherein the user interface generator.

44. An apparatus as recited in claim 42 further comprising:
a first user interface generator coupled to the first media access client, wherein the first user interface generator generates a first user interface based on information received from the first media access client; and
a second user interface generator coupled to the second media access client, wherein the second user interface generator generates a second user interface based on information received from the second media access client.

45. An apparatus as recited in claim 44 wherein the first user interface includes information regarding media items stored in the media database.

46. An apparatus as recited in claim 44 wherein the first user interface includes information regarding media files stored in the media database, media lists stored in the media database, and information regarding the first media device.

47. An apparatus comprising:
means for identifying at least one media item, at least one media list, and at least one media device;
means for storing information regarding the at least one media item, the at least one media list, and the at least one media device;
means for providing information regarding the at least one media item, the at least one media list, and the at least one media device to a requesting media access client;
wherein the means for identifying at least one media item, at least one media list, and at least one media device further performs media-related operations for the requesting media access client.

48. An apparatus as recited in claim 47 further comprising means for generating a user interface containing information related to the at least one media item, at least one media list, and at least one media device.

49. An apparatus as recited in claim 47 wherein the one or more media lists include audio files associated with a particular artist.

50. An apparatus as recited in claim 47 wherein the one or more media lists include audio files associated with a particular album.

51. An apparatus as recited in claim 47 wherein the one or more media lists include audio files associated with a particular genre of music.

52. One or more computer-readable media having stored thereon a computer program that, when executed by one or more processors, causes the one or more processors to:
receive a request for media data from a media access client;
identify one or more stored audio files;
identify one or more stored media lists;
identify one or more media devices; and
provide information regarding the one or more stored audio files, the one or more stored media lists, and the one or more media devices to the media access client.

53. One or more computer-readable media as recited in claim 52 wherein the one or more processors further categorize the information regarding the one or more stored audio files, the one or more stored media lists, and the one or more media devices.

54. One or more computer-readable media as recited in claim 52 wherein the one or more processors further performs media-related operations for the requesting media access client.
